(19) United States
(12) Patent Application Publication
(10) Pub. No.: US 2013/0239802 A1
(43) Pub. Date: Sep. 19, 2013

(54) SELF-CLEANING AIR FILTER

(71) Applicant: Jason D. Troxell, Clarendon Hills, IL (US)

(72) Inventor: Jason D. Troxell, Clarendon Hills, IL (US)

(73) Assignee: Maradyne Corporation, Cleveland, OH (US)

(21) Appl. No.: 13/832,519

(22) Filed: Mar. 15, 2013

Related U.S. Application Data
(63) Continuation-in-part of application No. 13/748,406, filed on Jan. 23, 2013.
Application No. 13/748,406 is a continuation of application No. 12/924,352, filed on Sep. 24, 2010, now Pat. No. 8,382,870.

(51) Int. Cl. B01D 46/00

(52) U.S. Cl. CPC B01D 46/0068
USPC 95/20; 55/283

(57) ABSTRACT

A system and method to control cleaning of an associated air filter apparatus is disclosed. Air flow across the associated air filter is estimated using a pressure sensor disposed at an inlet port of the associated air filter and a pressure sensor disposed at an outlet port of the associated air filter. Further, an optimal air flow across the associated air filter is calculated. The optimal air flow results in optimal filtering efficiency. The associated air filter is then periodically cleaned at a rate determined from the difference between the estimated air flow and the calculated optimal air flow to move air flow towards the optimal air flow.

The instant application is a continuation-in-part of application Ser. No. 13/748,406, which was filed Jan. 23, 2013 and is still pending. That application is a continuation of application Ser. No. 12/924,352, filed Sep. 24, 2010 and issued on Feb. 26, 2013 as U.S. Pat. No. 8,382,870.

This invention relates to a self-cleaning air filter, and in particular a self-cleaning air filter for vehicles and motorized equipment.

### BACKGROUND OF THE INVENTION

Operating in dusty environments has long been a problem for equipment and vehicles. The respiration of dusty and contaminated air greatly hinders performance and can damage the vehicle or equipment's engines. Even though vehicles and equipment have filter elements that filter the inlet air flow, in extremely dusty environments, these filter elements quickly become caked with dust and debris, which retards and stops the air flow through the filter element to the engine. Consequently, these filter elements must be frequently cleaned to remove the deeply imbedded dust which penetrates into the filter element or the entire filter element must be replaced to ensure the proper operation of the equipment and vehicles. In extremely dusty environments, the demand of constantly cleaning and/or replacing filter elements comes at a significant cost of time and money.

A technique commonly referred to as “pulse jet” or “reverse pulse” self-cleaning has been used in industrial and large scale air filtration systems. Reverse pulse self-cleaning involves periodically releasing a quick burst (“pulse”) of compressed air into the filter element, which expands through the filter element in the opposite direction of the normal airflow through the filter element. The rapidly expanding compressed air pulse passing out of the filter element dislodges the dust cake collected on the outside of the filter element, as well as some dust which has penetrated into the element pleat. While effective for industrial and large scale air filtration systems, reverse pulse self-cleaning, heretofore, has been inoperable for small air filtration systems, such as those for vehicles and other types of motorized equipment. Reverse pulse self-cleaning works in industrial and large scale air filtration systems because of the sheer volume of the filter housing and the volume of the filter housings in relation to the volume of the filter elements.

In industrial and large scale applications, multiple arrays of filter elements are disposed within large volume filter housings. These filter housings are spacious enough that the compressed air pulse can propagate through the filter elements to effectively clean them before energy of the pulse dissipates within the filter housing and the pressure differential equalizes returning the system to its normal filtering operation.

In small scale applications, such as for vehicles and motorized equipment, where space is limited, the filter housings lack the volume in relation to the volume of the filter elements to make reverse pulse self-cleaning operable or effective. In such applications, a single filter element is typically disposed within the limited confines of the filter housing. The filter housings provide little volume around the filter element within which a compressed air pulse can expand and dissipate. Consequently, an expanding compressed air pulse almost instantly equalizes the pressure differential between the inside and outside of the filter element within the filter housing, which prematurely terminates the expansion of the pulse through the filter element. As a result, the effectiveness of the pulse jet self-cleaning action is lost or greatly reduced.

### SUMMARY OF THE INVENTION

The present invention provides a system for controlling cleaning of an associated air filter apparatus. The system includes processing circuitry configured to estimate air flow across the associated air filter using a pressure sensor disposed at an inlet port of the associated air filter and a pressure sensor disposed at an outlet port of the associated air filter. The processing circuitry is further configured to calculate an optimal air flow across the associated air filter and periodically clean the associated air filter at a rate determined from the difference between the estimated air flow and the calculated optimal air flow to move air flow towards the optimal air flow. The optimal air flow results in optimal filtering efficiency.

The present invention further provides a method for controlling cleaning of an associated air filter apparatus. The method is performed by processing circuitry. Air flow across the associated air filter is estimated using a pressure sensor disposed at an inlet port of the associated air filter and a pressure sensor disposed at an outlet port of the associated air filter. An optimal air flow across the associated air filter is calculated. The optimal air flow results in optimal filtering efficiency. The associated air filter is periodically cleaned at a rate determined from the difference between the estimated air flow and the calculated optimal air flow to move air flow towards the optimal air flow.

The present invention further provides a self-cleaning air filter apparatus connected to a compressed air source. The apparatus includes a filter element configured to filter air flowing through the air filter apparatus and a pulse valve. The pulse valve is connected to the compressed air source and configured to selectively release a pulse of compressed air into the filter element to clean the filter element. The apparatus further includes a control module connected to the pulse valve. The control module is configured to estimate air flow across the air filter apparatus using a pressure sensor disposed at an inlet port of the air filter apparatus and a pressure sensor disposed at an outlet port of the air filter apparatus. Further, the control module is configured to calculate an optimal air flow across the air filter apparatus. The optimal air flow results in optimal filtering efficiency. The control module is further configured to, using the pulse valve, periodically release a pulse of compressed air at a rate determined from the difference between the estimated air flow and the calculated optimal air flow to move air flow towards the optimal air flow.

### BRIEF DESCRIPTION OF THE DRAWINGS

The drawings illustrate an embodiment of the present invention, in which:

FIG. 1 is a perspective view of an embodiment of the air filter of this invention;

FIG. 2 is a partial exploded view of the air filter of FIG. 1 showing the pressure relief valve and a portion of the filter casing;

FIG. 3 is an exploded view of the pressure relief valve of FIG. 1;

FIG. 4 is a side view of the pressure relief valve of FIG. 1;

FIG. 5 is an end view of the pressure relief valve of FIG. 1;

FIG. 6 is a side sectional view of the air filter of FIG. 1 shown during the normal filtering cycle;

FIG. 7 is a side sectional view of the air filter of FIG. 1 shown during the cleaning cycle;

FIG. 8 is a partial perspective view of an exemplary application of the air filter of FIG. 1 used in a typical military style vehicle; and

FIG. 9 is a simple schematic of the air filtration system using the air filter of FIG. 1.

FIG. 10 is a flow chart of a method for controlling a pulse valve employed for cleaning the air filter of FIG. 1.

FIG. 11 is a graph illustrating differential pressure across the air filter of FIG. 1 over the life of the air filter when the method of FIG. 10 is employed.

FIG. 12 is an enlarged view of a portion of the plateaued region of FIG. 11.

FIG. 13 is a graph representing a model relating the extent of clogging to pulse interval.

### DESCRIPTION OF THE PREFERRED EMBODIMENT

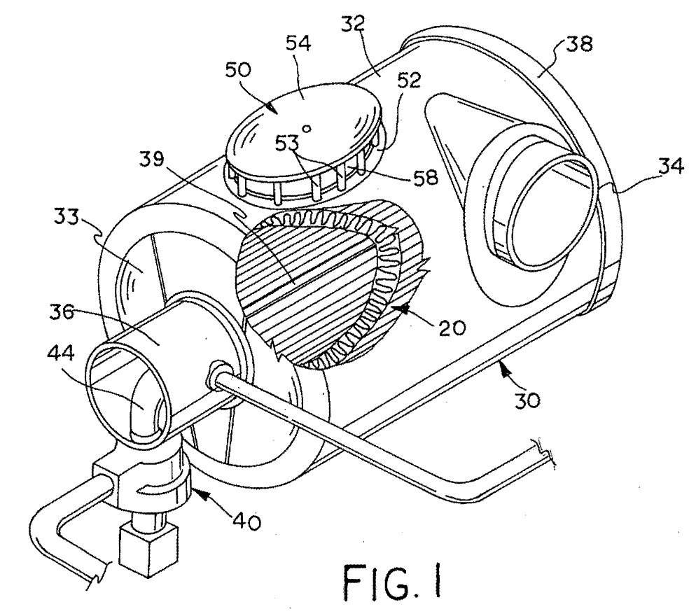

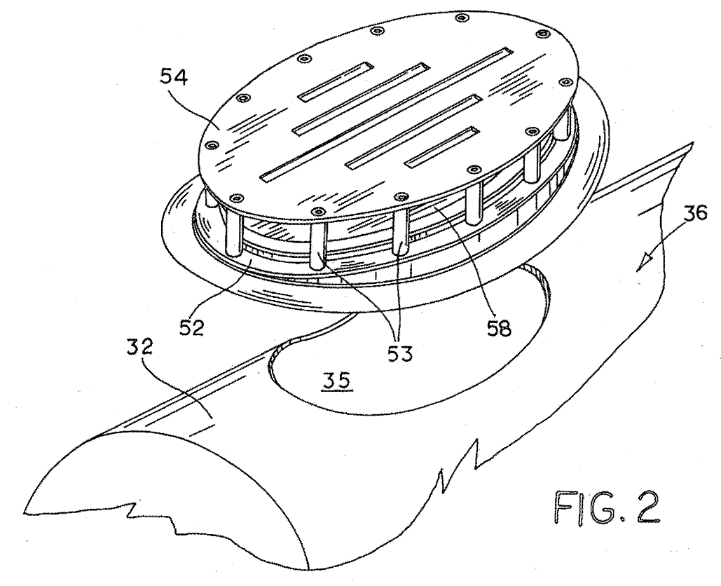

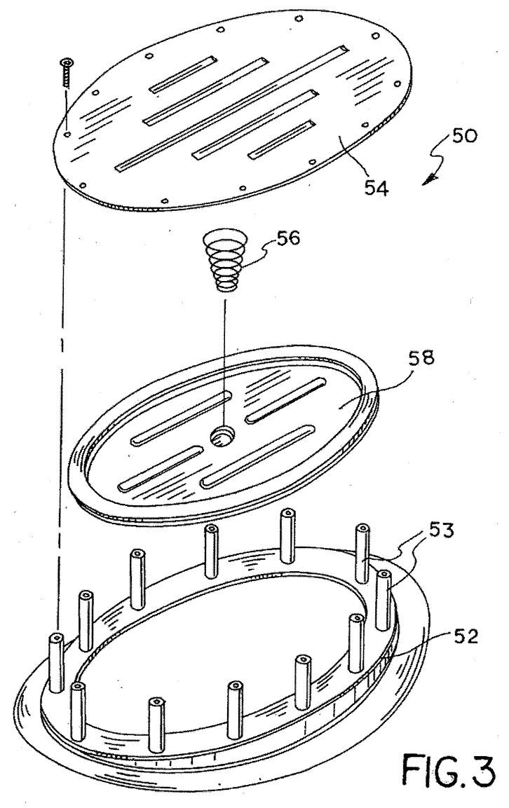

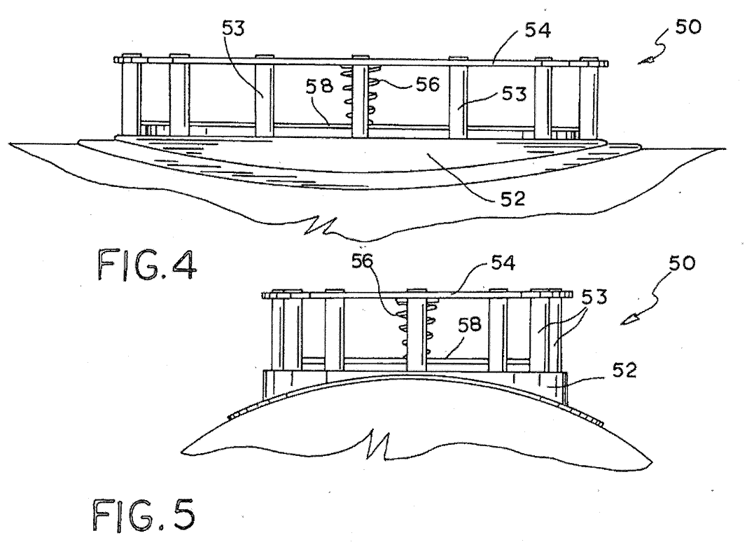

FIGS. 1-13 illustrate an embodiment of the self-cleaning air filter of this invention, which is designated generally as reference numeral 10. As shown, air filter 10 includes a tubular filter element 20 disposed within a cylindrical filter casing 30. Filter element 20 is of conventional design and function having a tubular sidewall of pleated filter material, which collects dust and debris as air passes through. Filter element 20 is typically constructed of a blend of cellulose and synthetic fibers. Further, a synthetic fine fiber coating is typically applied to the surface of the media. Other constructions are, however, contemplated. For example, filter element 20 can be constructed of all synthetic fibers rather than conventional paper. Filter element 20 is axially centered within filter casing 30. The tubular sidewall of filter element 20 is inset from the casing sidewalls defining an open space 13 around the outside of the filter element. The tubular sidewall also defines an open interior space 15 within filter element 20. Filter casing 30 has an open end enclosed by a removable lid 38. Lid 38 allows filter element 20 to be replaced as desired. Lid 38 is secured to casing 30 by connecting rod 39, which extends axially through filter element 20. Filter casing 30 includes an exterior surface 32 and an inlet port 34, through which dust laden air 100 from the atmosphere enters one end (the “inlet end”) of air filter 10 and an outlet port 36 through which clean filtered air 104 exits the opposite end (the “outlet end”) of the air filter. As shown, inlet port 34 extends tangentially from the casing sidewall at the inlet end of filter casing 30 and an outlet port 36 that extends axially from the casing bottom 33 at the outlet end of casing 30. Outlet port 36 allows for connection to the air intake and fuel induction system of a combustion engine by a hose, pipe or duct, although air filter 10 can be integrally mounted to the engine's air intake and fuel injection systems as desired.

A pulse valve 40 is mounted to the side of outlet port 36 and operably connected to a compressed air source 60. Pulse valve 40 releases short blasts or pulses of compressed air from the compressed air source within filter element 20, which facilitates the self-cleaning action of air filter 10. In one embodiment, pulse valve 40 is a conventional solenoid type control valve where a solenoid (not shown) actuates a diaphragm (not shown) to open and close the valve. Pulse valve 40 is mounted to the side of outlet port 36. An elbow 44 connects the output of pulse valve 40 to a nozzle head 46, which is centered along the longitudinal axis of filter casing 30. Nozzle head 46 includes a conical deflector 48, which deflects the pulse of compressed air radially through filter element 20. Pulse valve 40 is under the control of an electronic control module 42, which actuates the solenoid to open and close the valve at predetermined intervals. Control module 42 is electrically powered by any available internal or external power source, but is generally powered using the electrical power source found in the equipment or vehicle. Control module 42 may include processing circuitry 37, memory 39 and an I/O interface 41 for connection to other control system sensors and devices. The processing circuitry generally includes a suitable general purpose computer processing circuit, such as a microprocessor and its associated circuitry. The processing circuit is operable to carry out the operations attributed to it herein. Within the memory are various program instructions. The program instructions are executable by the processing circuit and/or any other components of the control module 42 as appropriate. If desired, one or more of the components of the control module 42 may be provided as a separate device, which may be remotely located from the other components of the control module.

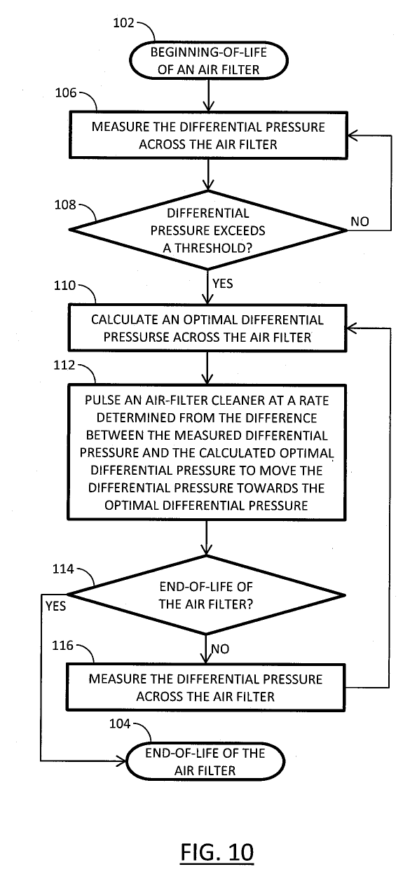

In some embodiments, control module 42 controls pulse valve 40 based on flow through air filter 10. In that regard, control module 42 receives measurements of parameters that can be used to measure air flow, or estimate air flow, through air filter 10 from one or more sensors 43, 45. Such parameters can include, for example, one or more of a) air pressure at inlet port 34; b) air pressure at the outlet port 36; c) air flow at the inlet port; and d) air flow at the outlet port. One or more sensors 43, 45 can include, for example, one or more of air flow sensors (e.g., pitot tubes and/or anemometers) and air pressure sensors (e.g., vacuum transducers). Also, one or more sensors 43, 45 can be used independently or concurrently. In one embodiment, a first vacuum transducer 43 measures air pressure at inlet port 34 and a second vacuum transducer 45 measures air pressure at outlet port 36. Received parameter measurements are applied to a model relating the parameters to pulse rate to determine how to control pulse valve 40. Pulse valve 40 is then controlled to pulse in accordance with the determination. One such model is described in connection with FIGS. 10-13, discussed below.

Further, in some embodiments, control module 42 can interface with external systems and/or devices over SAE J1939/CAN OPEN protocols using I/O interface 41. Using these protocols, control module 42 can be programmed and/or configured. For example, user-defined constants used in the model can be set using these protocols. As another example, the model can be configured and/or specified using these protocols.

Air filter 10 also includes a spring loaded pulse pressure vent (PPV) 50, which vents the compressed air pulse from filter casing 30 during the self-cleaning cycle of air filter 10. PPV 50 also acts as a vent for the dust removed during cleaning to be blown out of the housing. PPV 50 vents the over-pressure on the outside of filter element 20 from the compressed air pulse so that a pressure differential is maintained between the inside and outside of the filter element so that the cleaning action is maintained through the cleaning cycle. PPV 50 also acts as a vent for the dust removed during cleaning to be manually blown out of filter casing 30. PPV 50 is mounted between the inlet and outlet ends of filter casing 30 within an opening 35 in the casing sidewall. PPV 50 includes an annular nozzle ring 52, which is securely seated within opening 35 of filter casing 30. A plurality of spacers or posts 53 extending from nozzle ring 52 suspend a cover plate 54 over opening 35. A helical spring 56 biases a rigid diaphragm with a pliable seal 58 against nozzle ring 52 to hold PPV 50 closed sealing filter casing 30. Spring 56 is selected so that PPV 50 opens at a predetermined positive pressure within filter casing 30.

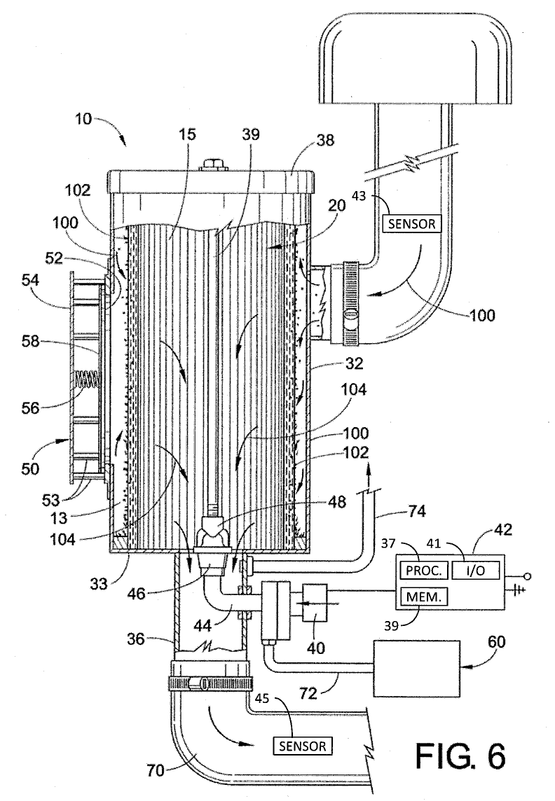

During the normal filtering cycle (FIG. 6), the operation of the combustion engine creates a negative pressure differential between the inside and outside of filter element 20, which draws the airflow through air filter 10. Dust laden air from the atmosphere enters air filter casing 30 through inlet port 34. The dust laden air surrounds filter element 20 in area 13 and is drawn inward through the filter element 20 where dust and debris collect on the outside of the filter element. The now “filtered” air exits air filter 10 to the engine through outlet port 36. As shown, PPV 50 is closed during the normal filtering cycle.

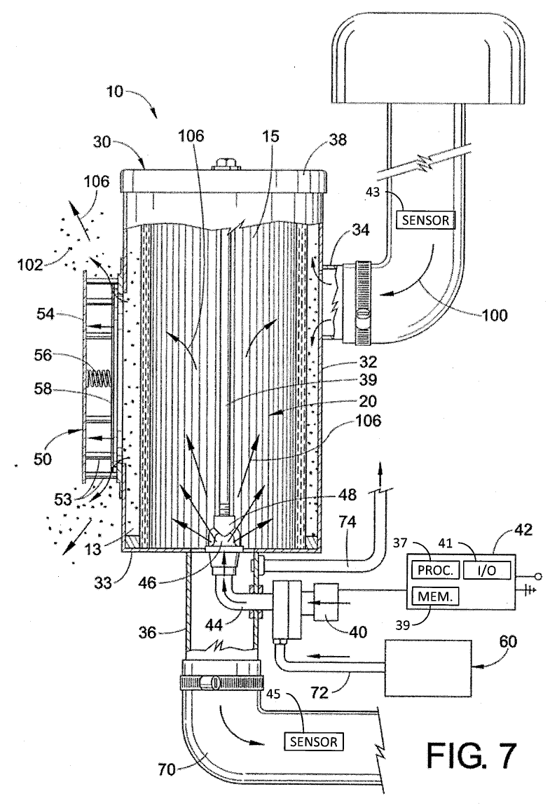

During the cleaning cycle (FIG. 7), pulse valve 40 releases a short powerful blast of compressed air (the “compressed air pulse”) into filter element 20, which dislodges dust and debris 102 from the filter element into area 13 thereby providing the self-cleaning action of air filter 10. Nozzle head 46 directs the compressed air pulse onto the deflector 48, which projects the compressed air pulse outward radially into the filter element. The compressed air pulse creates a high pressure wave that expands outward radially through filer element 20 as it moves along the length of filter element 20 from the outlet end to the inlet end. The high pressure wave created by the compressed air pulse briefly inverts the pressure differential between the inside and outside of filter element 20 and temporarily reverses the direction of air flow through filter element 20 thereby providing the cleaning action. In releasing the compressed air pulse, pulse valve 50 opens only for a brief duration generally 5-10 milliseconds. The cleaning cycle is maintained only as long as the positive pressure differential between the inside and outside of the filter element can be maintained. Consequently, the cleaning cycle lasts less than a few tenths of a second.

During the brief cleaning cycle, the over pressure of the compressed air pulse expanding through filter element 20 immediately opens PPV 50. PPV 50 opens once the internal air pressure of filter casing 30 reaches its predetermined pressure. PPV 50 opens to vent the compressed air pulse to the atmosphere thereby maintaining the now positive pressure differential between the inside and the outside of filter element 20. Venting the compressed air pulse to the atmosphere sustains the cleaning action for the entire duration of the pulse and allows the high pressure wave of the compressed air pulse to traverse the length of the filter element providing an efficient cleaning of the entire filter element. Without PPV 50 venting the compressed air pulse to the atmosphere, the pressure differential between the inside and outside of filter element 20 would quickly equalize within the confined space of filter casing 30 thereby interrupting the cleaning action provided by the compressed air pulse. Once the compressed air pulse has been vented from filter casing 30, the positive pressure differential is lost and the vacuum draw from the outlet port 36 quickly reestablishes the negative pressure differential between the inside and outside of the filter element, whereby the air flow direction through air filter 10 reverts back and the normal filtering cycle is reestablished.

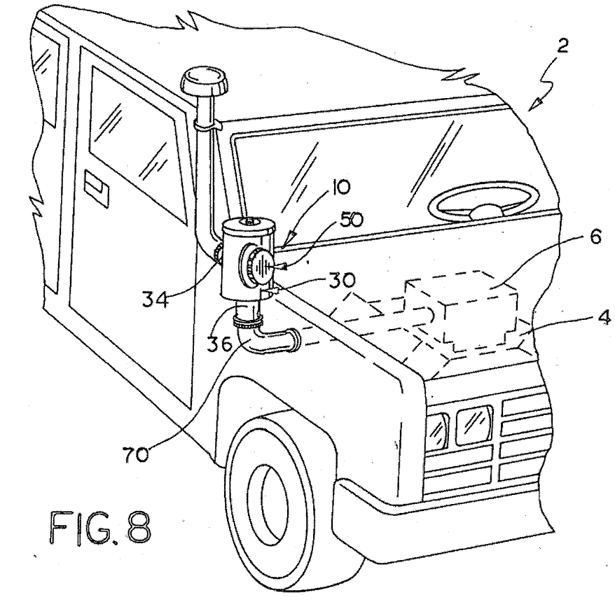

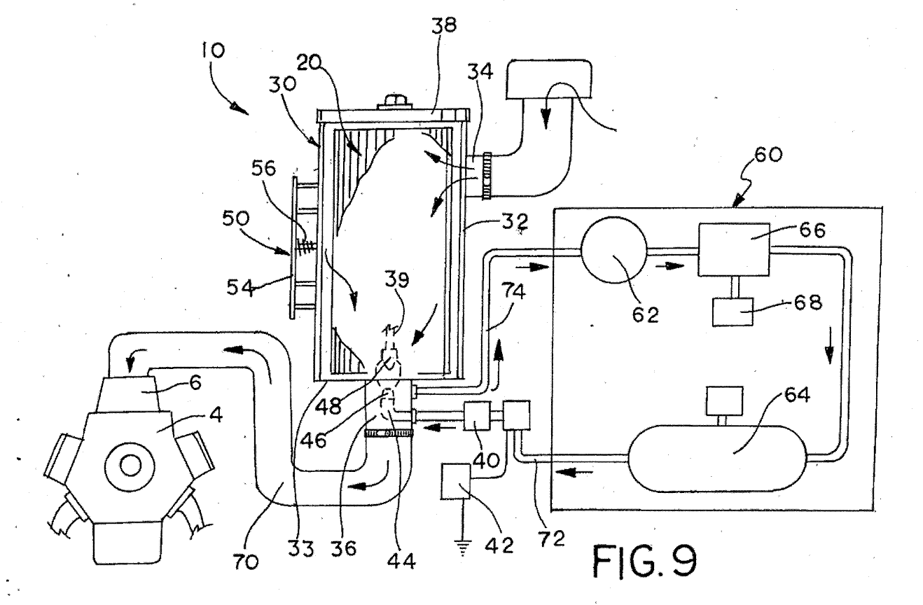

In certain embodiments, air filter 10 forms part of an integrated air filtration system in equipment or vehicles powered by any internal combustion engine that operates in environments with extremely high contents of dust, sand and other particulate in the atmosphere. By way of example only and for simplicity of illustration and explanation, FIGS. 8 and 9 illustrate the application of air filter 10 to an air filtration system of a military type vehicle 2. In other embodiments, the air filtration system and the air filter may take other forms and be adapted for the desired application within the scope of this invention.

FIG. 8 depicts air filter 10 mounted to vehicle 2 outside of the engine compartment. The compressed air source (not shown in FIG. 8) is typically mounted to the vehicle undercarriage or within the engine compartment, which contains an engine 4. It should be noted that in other applications, air filter 10 and the compressed air source may be located in any available space and suitable location on, in or outside of the vehicle or equipment as desired for the particular application.

FIG. 9 depicts a schematic of air filter 10 incorporated into an air filtration system of vehicle 2. Pulse valve 40 is connected to compressed air source 60 by air line 72. Another air line 74 supplies compressed air source 60 with filtered air from outlet port 36 of air filter 10 thereby ensuring that the volume of compressed air supplied back to pulse valve 40 is contaminant free. A hose, pipe or duct 70 connects outlet port 36 of air filter 10 to the engine's air intake and fuel injection system 6.

Compressed air source 60 supplies the volume of clean compressed air to air filter 10 from which the compressed air pulse is released within filter element 20 to facilitate the self-cleaning action. The necessary volume and pressure of the compressed air supplied from the compressed air source is determined by several factors, including, but not limited to the volume and configuration of air filter 10, the type of filter element 20, the volume and properties of dust within the inlet airflow, and the frequency of the air filter's cleaning cycle. Air filter 10 can be connected to any suitable and available compressed air source, whether specifically dedicated to supplying the air filter or one presently existing in the equipment or vehicle application that is available to supply the air filter. As shown, compressed air source 60 includes a compressor unit 62, a storage tank 64, a compressed air dryer 66 and moisture drain switch 68. Compressed air source 60 may also include other ancillary components (not shown), such as, but not limited to, compressed air filters, water purge valves, pressure gages and switches, hoses, lines, clamps and fittings. Generally, the components which make up the compressed air source 60 are of conventional design well known in the art. Compressor unit 62, storage tank 64 and other components of compressed air source 60 are selected so that the compressed air source supplies air filter 10 with the volume of clean, compressed air necessary for generating the required compressed air pulse within the air filter.

One skilled in the art will note that this invention enables the use of reverse pulse self-cleaning in small scale applications, such as for vehicles and motorized equipment. The pulse pressure vent compensates for the filter casing's small confined volume where the compressed air pulse is normally dissipated in large industrial systems by venting the compressed air pulse from the casing. The pulse pressure vent opens at a preset positive pressure so that the compressed air pulse vents to the atmosphere once it passes through the filter element. The pulse pressure vent maintains the positive pressure differential between the inside and outside of the filter element, which sustains the cleaning action during the cleaning cycle. Without the pulse pressure vent, the compressed air pulse would almost instantly expand within the confined volume of the filter casing and equalize the pressure differential between the inside and the outside of the filter element abruptly terminating the cleaning action before the pulse could clean the entire filter element. Venting the compressed air pulse through the pulse pressure vent allows the pressure wave of the pulse to travel the length of the filter element and the energy in the pulse to effectively dislodge dust from the filter element. The vent also provides an egress path from the filter casing for the dust and debris during the cleaning cycle. The pulse pressure vent can be readily adapted for filter housings of any size, configuration or capacity in a variety of vehicle, equipment and other applications. In addition, the pressure setting, size, configuration and location of the pulse pressure valve between the inlet and outlet ends of the filter casing is selected so that the compressed air pulse can be vented as the pulse travels the length of the filter element, thereby ensuring the entire area of the filter element will be cleaned.

FIGS. 10-13 illustrate a flowchart of a method 100 by which control module 42 controls pulse valve 40 to clean air filter 10. Method 100 can be implemented as program instructions stored in memory 39 of control module 42 and executed by processing circuitry 37 of control module 42. The flowchart spans from a beginning-of-life 102 of air filter 10 to an end-of-life 104 of the air filter. Beginning-of-life 102 corresponds to the point in the life cycle of air filter 10 when the air filter has not been used or is clean. End-of-life 104 corresponds to the point in the life cycle of air filter 10 when the air filter is no longer performing according to specification or is otherwise unsuitable for continued air filtering.

Referring to FIG. 10, at beginning-of-life 102 of air filter 10, a current differential air pressure ΔP_{ACT} across inlet port 34 and outlet port 36 is measured 106 during normal operation of the vehicle. In one embodiment, to measure differential pressure ΔP_{ACT}, an air pressure IP_{ACT} at inlet port 34 during normal operation of the vehicle is measured using first vacuum transducer 43 and an air pressure OP_{ACT} at outlet port 36 during normal operation of the vehicle is measured using second vacuum transducer 45. Thereafter, the difference between the two pressures is calculated to determine differential pressure ΔP_{ACT}=OP_{ACT}−IP_{ACT}. In another embodiment, differential pressure ΔP_{ACT} is estimated from pressure I_{ACT}.

To estimate differential pressure ΔP_{ACT}, pressure I_{ACT} is measured using first vacuum transducer 43. Further, an air pressure OP_{HI} at outlet port 36 and an air pressure IP_{HI} at inlet port 34 are determined when the vehicle engine is at full load or high idle and air filter 10 is new and clean. Thereafter, the ratio between pressure I_{ACT} and pressure IP_{HI} is determined:

$$\frac{{IP}_{ACT}}{{IP}_{HI}} .$$

The ratio is applied to scale a differential air pressure ΔP_{HI}OP_{HI}−IP_{HI} across air filter 10 when the vehicle engine is at full load or high idle and air filter 10 is new and clean is determined

$$Δ {P}_{HI} \frac{{IP}_{ACT}}{{IP}_{HI}} .$$

This scaled differential pressure corresponds to an estimate of differential pressure ΔP_{ACT}. Pressure IP_{HI}, pressure OP_{HI} and differential pressure ΔP_{HI} can be determined at beginning-of-life 102 of air filter 10 or determined from another air filter of the same type as air filter 10 at the beginning-of-life of the other air filter.

After measuring differential pressure ΔP_{ACT}, a determination 108 is made as to whether differential pressure ΔP_{ACT} exceeds a threshold T. If differential pressure ΔP_{ACT} fails to exceed threshold T, differential pressure ΔP_{ACT} is measured 106 again and determination 108 is repeated. Optionally, the re-measurement can be delayed by a predetermined amount of time (e.g., one minute). Until threshold T is exceeded, pulse valve 40 is disabled and cleaning is disabled.

Threshold T is typically set at a level that allows an optimal amount of dust to build up in air filter 10 before cleaning of the air filter can begin. This recognizes that, generally, in dust collection and self-cleaning, some amount of dust on air filter 10 is desirable for maximum cleaning efficiency. Typically, the optimal amount of dust increases pressure differential ΔP_{H}, by 2-4 pounds per square inch (psi). Alternatively, threshold T can be set to allow more or less than an optimal amount of dust to build up, or to allow cleaning to begin immediately.

While not necessary, threshold T is typically based off pressure differential ΔP_{HI} and a caking factor CA_{F}. Caking factor CA_{F} is a constant entered by user of control module 42 that specifies an air pressure increase above pressure differential ΔP_{H}, when the vehicle engine is at full load or high idle and air filter 10 is new and clean. Caking factor CA_{F} is typically set to achieve the optimum amount of dust buildup for filtration. Threshold T at full load or high idle is the summation of differential pressure ΔP_{HI} and caking factor CA_{F}. However, when not at full load or high idle, differential pressure ΔP_{HI} and caking factor CA_{F} need to be scaled to determine threshold

$$T = ( ( \frac{{IP}_{ACT}}{{IP}_{HI}} ) Δ {P}_{HI} ) + ( ( \frac{{IP}_{ACT}}{{IP}_{HI}} ) {CA}_{F} ) .$$

As should be appreciated, the scaling is done as described above to estimate differential pressure ΔP_{ACT}.

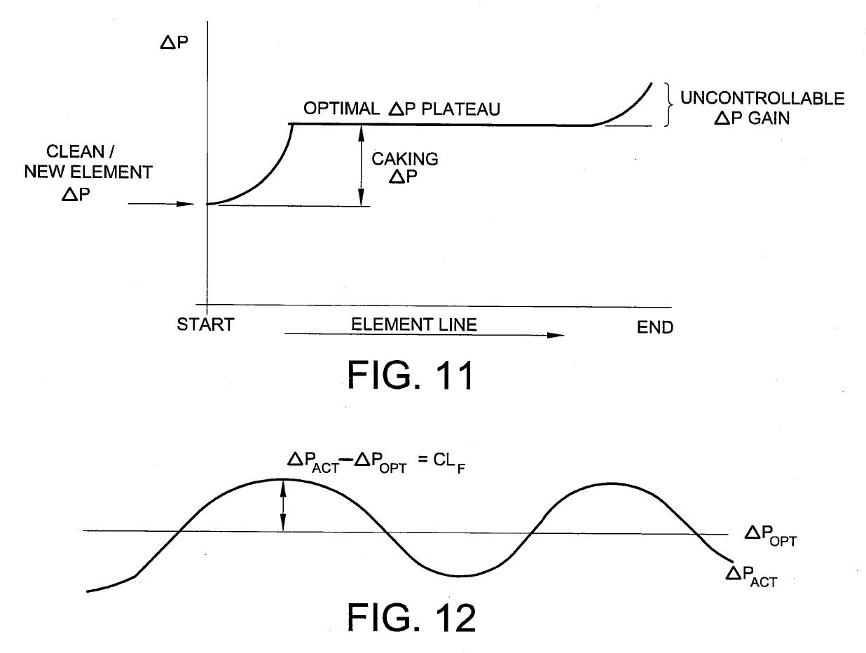

With reference to FIG. 11, an example graphical representation of pressure differential ΔP_{ACT} over the life of air filter 10 is illustrated. The vertical axis corresponds to pressure differential ΔP_{ACT} (e.g., in psi) and the horizontal axis corresponds to the life of air filter 10 (e.g., in hours). As can be seen, pressure differential ΔP_{ACT} gradually increases before plateauing. The level at which pressure differential ΔP_{ACT} stops gradually increasing is defined by threshold T.

Once differential pressure ΔP_{ACT} exceeds threshold T, an optimal differential air pressure ΔP_{OPT} across air filter 10 at the current load is calculated 110. In some embodiments, differential pressure ΔP_{OPT} is the same as threshold T. In that regard, differential pressure ΔP_{OPT} is typically equal to

$$( ( \frac{{IP}_{ACT}}{{IP}_{HI}} ) Δ {P}_{HI} ) + ( ( \frac{{IP}_{ACT}}{{IP}_{HI}} ) {CA}_{F} ) .$$

As should be appreciated, differential pressure ΔP_{OPT} varies as engine load changes (i.e., as the revolutions per minute (RPM) of the engine changes). For example, a reduction in RPM results in a reduction of differential pressure ΔP_{OPT}. After calculating differential pressure ΔP_{OPT}, the difference between differential pressure ΔP_{ACT} and differential pressure ΔP_{OPT} is calculated as a clogging factor CL_{F}=ΔP_{ACT}−ΔP_{OPT}, as illustrated in FIG. 12. FIG. 12 shows an enlarged view of a portion of the plateaued region of FIG. 11. The vertical axis corresponds to pressure differential ΔP_{ACT} and the horizontal axis corresponds to the life of air filter 10.

The foregoing calculated clogging factor CL_{F} by down scaling differential pressure ΔP_{HI} and clogging factor CA_{F}. In some embodiments, clogging factor CL_{F} can instead be calculated by upscaling differential pressure ΔP_{ACT} as follows:

$${CL}_{F} = ( \frac{{IP}_{HI}}{{IP}_{ACT}} ) Δ {P}_{ACT} - Δ {P}_{HI} - {CA}_{F} .$$

Clogging factor CL_{F} is input into a model relating clogging factor CL_{F} to the pulse interval for cleaning pulses to calculate the current pulse interval. The model includes upper and lower bounds on the pulse interval, such as two minutes and one hour, respectively. Further, the model can include upper and lower bounds on clogging factor CL_{F}, which correspond to the lower and upper bounds on the interval, respectively. Typically, as clogging factor CL_{F} increases, the pulse interval decreases, and vice versa. If clogging factor CL_{F} is less than its lower bound, the pulse interval will be the greatest allowed pulse interval (e.g., one hour). Similarly, if clogging factor CL_{F} is greater than its upper bound, the pulse interval will be the smallest allowed pulse interval (e.g., two minutes). The model is suitably defined by a user of control module 42, for example, by defining lower and upper bounds for clogging factor CL_{F} and the pulse interval.

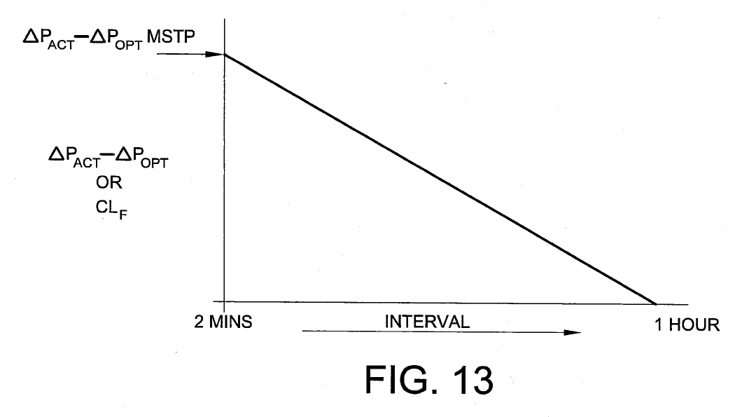

FIG. 13 illustrates a linear model relating clogging factor CL_{F} to the pulse interval for cleaning pulses. The vertical axis corresponds to clogging factor CL_{F}, and the horizontal axis corresponds to the pulse interval spacing in time units. As illustrated, the pulse interval increases linearly as clogging factor CL_{F} increases and decreases linearly as clogging factor CL_{F} decreases. In some embodiments, the model may be exponential.

In some embodiments, the model adds a scaling factor to increase the pulse interval for low engine loads (e.g., low engine RPM). Namely, flow rate through air filter 10 decreases as engine load decreases. Through testing, it has been found that the optimal pulse interval for low engine loads does not necessarily correspond to the optimal pulse interval for higher engine loads. The pulse intervals at low engine loads are too high. Hence, a scaling factor can be added for lower engine loads to decrease the pulse interval. For example, the scaling factor can increasingly decrease the interval as engine load decreases.

After calculating the pulse interval, pulse valve 40 is pulsed 112 according to the pulse interval to clean air filter 10. A determination 114 is then made as to whether air filter 10 has reached end-of-life 104. So long as air filter 10 has not reached end-of-life 104, differential pressure ΔP_{ACT} is measured 116 again and the foregoing is repeated starting from calculating 110 differential pressure ΔP_{OCT}. Optionally, the re-measurement can be delayed by a predetermined amount of time (e.g., one minute). If air filter 10 has reached end-of-life 104, a user of control module 42 can be notified by, for example, one or more of a light, audible alarm, display readout, or by interface to the vehicle computer and a display location of the vehicle manufacturer's choice.

End-of-life 104 can be determined in any number of ways. For example, end-of-life 104 can be a predetermined time duration from beginning-of-life 102. As another example, end-of-life 104 can be the time point at which differential pressure ΔP_{ACT} is no longer controllable at the maximum pulse frequency (i.e., lowest pulse interval). This can be determined through historical analysis of previous pulse intervals used with pulse valve 40. If the smallest pulse interval was previously used with pulse valve 40, and a predetermined amount of time has elapsed, with no improvement in clogging factor CL_{F}, differential pressure ΔP_{ACT} is no longer controllable. FIG. 11 illustrates this uncontrolled differential pressure ΔP_{ACT}ΔP_{ACT} can be monitored for signs that end-of-life 104 is reached.

In view of the foregoing, differential pressure ΔP_{ACT} is actively controlled by changing the pulse interval to maintain differential pressure ΔP_{ACT} as close to differential pressure ΔP_{OPT} as possible. As clogging factor CL_{F} increases, the pulse interval of air valve 40 decreases. Eventually, clogging factor CL_{F} should start to fall again, whether this is due to the increased pulse frequency or simply an environment with light dust loading. The pulse frequency will then decrease until clogging factor CL_{F} increases again. In some instances, clogging factor CL_{F} continues to increase due to an extremely dusty environment or air filter 10 reaching end-of-life 104.

Further, in view of the foregoing, method 100 estimates flow or a percentage of full flow without utilizing a flow sensor. It is done with independent vacuum transducers. Advantageously, the vacuum transducers provide simplicity, reliability, and cost reduction as compared to approaches which directly measure air flow with an anemometer or a pitot tube. However, it is to be appreciated that direct measurements of air flow can be employed with the approach described herein. Flow can be directly measured using, for example, a pitot tube or an anemometer

When employing direct measurements of flow with method 100, differential pressure is replaced with the direct measurement of flow at inlet port 34. Further, the above described ratios are replaced with the ratio of flow F_{ACT} during normal operation of the vehicle and flow F_{HI} when the vehicle engine is at full load or high idle and air filter 10 is new and clean:

$$\frac{{F}_{ACT}}{{F}_{HI}} .$$

To illustrate, optimal flow F_{OPT} can be calculated as

$${F}_{ACT} + ( ( \frac{{F}_{ACT}}{{F}_{HI}} ) {CA}_{F} ) ,$$

and clogging factor CL_{F} can be calculated as F_{ACT}−F_{OPT}.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A system for controlling cleaning of an associated air filter apparatus, said system comprising:
processing circuitry configured to:
estimate air flow across the associated air filter using a pressure sensor disposed at an inlet port of the associated air filter and a pressure sensor disposed at an outlet port of the associated air filter;
calculate an optimal air flow across the associated air filter, the optimal air flow resulting in optimal filtering efficiency; and
periodically clean the associated air filter at a rate determined from the difference between the estimated air flow and the calculated optimal air flow to move air flow towards the optimal air flow.

2. The system according to claim 1, wherein the estimated air flow and the calculated optimal air flow are defined in terms of differential pressure across the associated air filter.

3. The system according to claim 1, wherein the processing circuitry is configured to:
estimate air flow across the associated air filter based on a ratio of: 1) pressure at the inlet port when the associated air filter is under full load and the associated air filter is clean and/or new; and 2) pressure at the inlet port.

4. The system according to claim 3, wherein the estimated air flow is the differential pressure across the associated air filter, when the associated air filter is under full load and the associated air filter is clean and/or new, scaled using the ratio.

5. The system according to claim 1, wherein the periodic cleaning is disabled until the estimated air flow exceeds a threshold.

6. The system according to claim 5, wherein the threshold is the calculated optimal air flow.

7. The system according to claim 1, wherein the processing circuitry is configured to:
apply the difference between the estimated air flow and the calculated optimal air flow to a model relating the difference to determine the rate.

8. The system according to claim 7, wherein the model increase the rate as the difference decreases and decrease the rate as the difference increases.

9. The system according to claim 1, wherein the processing circuitry is configured to:
periodically clean the associated air filter by controlling a valve of the associated air filter to release a pulse of compressed air at the rate.

10. A method for controlling cleaning of an associated air filter apparatus, said method performed by processing circuitry and comprising:
estimating air flow across the associated air filter using a pressure sensor disposed at an inlet port of the associated air filter and a pressure sensor disposed at an outlet port of the associated air filter;
calculating an optimal air flow across the associated air filter, the optimal air flow resulting in optimal filtering efficiency; and
periodically cleaning the associated air filter at a rate determined from the difference between the estimated air flow and the calculated optimal air flow to move air flow towards the optimal air flow.

11. The method according to claim 10, wherein the estimated air flow and the calculated optimal air flow are in terms of differential pressure across the associated air filter.

12. The method according to claim 10, further including:
estimating air flow across the associated air filter based on a ratio of: 1) pressure at the inlet port when the associated air filter is under full load and the associated air filter is clean and/or new; and 2) pressure at the inlet port.

13. The method according to claim 12, wherein the estimated air flow is the differential pressure across the associated air filter when the associated air filter is under full load and the associated air filter is clean and/or new scaled using the ratio.

14. The method according to claim 10, wherein the periodic cleaning is disabled until the estimated air flow exceeds a threshold.

15. The method according to claim 14, wherein the threshold is the calculated optimal air flow.

16. The method according to claim 10, further including:
applying the difference between the estimated air flow and the calculated optimal air flow to a model relating the difference to the rate to determine the rate.

17. The method according to claim 16, wherein the model increase the rate as the difference decreases and decrease the rate as the difference increases.

18. The method according to claim 10, further including:
periodically cleaning the associated air filter by controlling a valve of the associated air filter to release a pulse of compressed air at the rate.

19. A self-cleaning air filter apparatus connected to a compressed air source, said apparatus comprising:
a filter element configured to filter air flowing through the air filter apparatus;
a pulse valve connected to the compressed air source and configured to selectively release a pulse of compressed air into the filter element to clean the filter element; and
a control module connected to the pulse valve and configured to:
estimate air flow across the air filter apparatus using a pressure sensor disposed at an inlet port of the air filter apparatus and a pressure sensor disposed at an outlet port of the air filter apparatus;
calculate an optimal air flow across the air filter apparatus, the optimal air flow resulting in optimal filtering efficiency; and
using the pulse valve, periodically release a pulse of compressed air at a rate determined from the difference between the estimated air flow and the calculated optimal air flow to move air flow towards the optimal air flow.

20. The apparatus according to claim 19, wherein the estimated air flow and the calculated optimal air flow are defined in terms of differential pressure across the associated air filter.
